(19) United States
(12) Patent Application Publication
(10) Pub. No.: US 2012/0324287 A1
(43) Pub. Date: Dec. 20, 2012

(54) COMPUTING DEVICE AND METHOD FOR EXECUTING TEST PROGRAMS IN COMMAND-LINE INTERFACE

(75) Inventor: RONG-DER HUANG, Tu-Cheng (TW)

(73) Assignee: HON HAI PRECISION INDUSTRY CO., LTD., Tu-Cheng (TW)

(21) Appl. No.: 13/517,673

(22) Filed: Jun. 14, 2012

(30) Foreign Application Priority Data
Jun. 17, 2011 (TW) 100121333

(51) Int. Cl. G06F 11/28

(52) U.S. Cl. 714/27; 714/E11.178

(57) ABSTRACT

A computing device and method executes one or more test programs in a command-line interface (CLI). The computing device downloads one or more test programs for testing one or more parts from a server. The computing device sends the one or more test programs to the SUT via a specific cable, wherein the specific cable can transmit the one or more test programs at different baud rates. The computing device starts the CLI and control the SUT to execute the one or more test programs via the CLI, and receives a test report from the SUT after the one or more parts has been tested.

### BACKGROUND

1. Technical Field

Embodiments of the present disclosure relate to test technology, and particularly to a computing device, a storage medium, and a method for executing one or more test programs in a command-line interface (CLI).

2. Description of Related Art

A command-line interface (CLI) is a means of interaction between a user and a computer program. The CLI executes programs (e.g., command lines) input by the user in a computer. In some situations, the programs are not manually input by the user, but are invoked from other device. For example, the computer invokes the programs stored in a remote server and automatically executes the programs in the CLI. However, whether two or more programs are transmitted at different baud rates, the two programs cannot be transmitted by the same regular cable (e.g., RS-232 serial cable), and the two or more programs cannot be executed in the same CLI. Thus, there is room for improvement in the art.

### BRIEF DESCRIPTION OF THE DRAWINGS

FIG. 1 is a system view of one embodiment of a computing device including a command-line interface (CLI) control system.

FIG. 2 is a block diagram of one embodiment of the computing device included in FIG. 1.

FIG. 3 is a flowchart of one embodiment of a CLI control method using the computing device of FIG. 1.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computing system-readable medium or other storage device. Some non-limiting examples of non-transitory computing system-readable media include CDs, DVDs, BLU-RAY, flash memory, and hard disk drives.

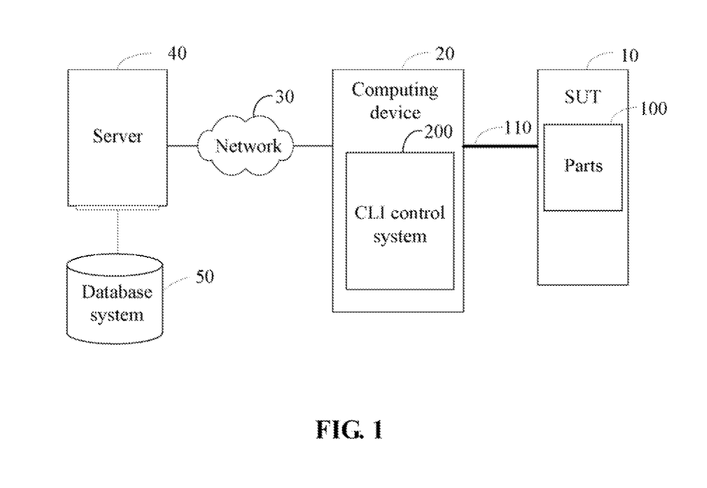

FIG. 1 is a system view of one embodiment of a computing device 20 including a command-line interface (CLI) control system 200. In one embodiment, the computing device 20 is connected to a server 40 via a network 30. The network 30 may be, but is not limited to, a wide area network (e.g., the Internet) or a local area network. In addition, the computing device 20 is also connected to a system under test (SUT) 10 via one or more cables 110. The cable 110 may be, but is not limited to, a RS-232 serial cable, or RS-232 serial Y cable. The CLI control system 200 may be used to execute test programs having different baud rates in a CLI. The CLI is displayed in a display device of the computing device 20. The test programs may be, but are not limited to, test scripts.

The SUT 10 includes one or more parts 100. The SUT 10 tests the one or more parts 100 and determines whether the one or more parts 100 are qualified or not. The one or more parts 100 may be, but are not limited to, a motherboard, a graphic card, a memory stick, a hard drive, or any other electronic parts.

A database system 50 is connected to the server 40 using open database connectivity (ODBC) or java database connectivity (JDBC), for example. The database system 50 may store one or more test programs for testing the one or more parts 100.

In one embodiment, the computing device 20 may be a personal computer (PC), a network workstation computer, or any other data-processing equipment.

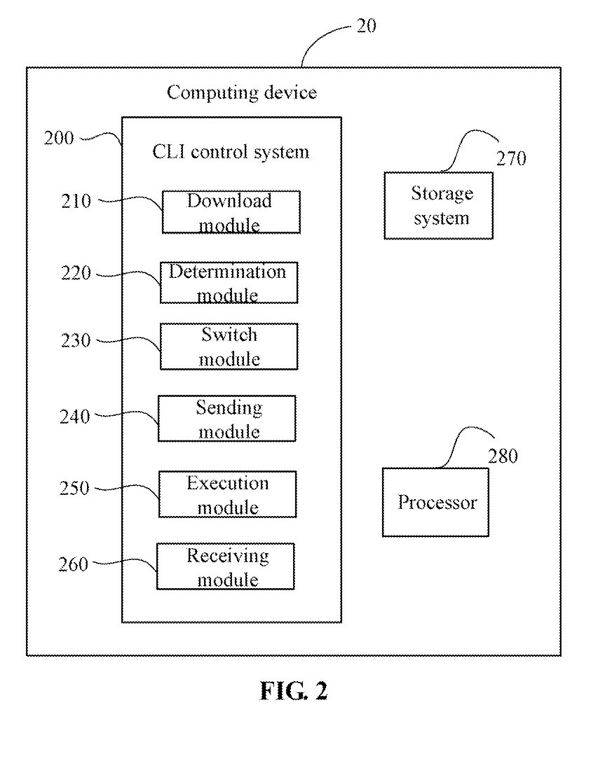

FIG. 2 is a block diagram of one embodiment of the computing device 20 included in FIG. 1. In the embodiment, the computing device 20 further includes a storage system 270 and at least one processor 280. In one embodiment, the CLI control system 200 includes a download module 210, a determination module 220, a switch module 230, a sending module 240, an execution module 250, and a receiving module 260. The modules 210-260 may include computerized code in the form of one or more programs that are stored in the storage system 270. The computerized code includes instructions that are executed by the at least one processor 280 to provide functions for modules 210-260. The storage system 270 may be a memory, such as an EPROM memory chip, HDD, or flash memory stick.

The download module 210 downloads the one or more test programs for testing the one or more parts 100 from the server 40. In one embodiment, each of the one or more test programs corresponds to a part 100 that is of a particular type. For example, whether the database system 50 stores three test programs, such as a first test program, a second test program, and a third test program. The first test program may correspond to the motherboard, the second test program may correspond to the graphic card, and the third test program may correspond to the memory stick.

Whether the SUT 10 includes only a motherboard, the download module 210 downloads the first test program from the database system 50 via the server 40. Whether the SUT 10 includes the motherboard and a graphic card, the download module 210 downloads the first test program and the second test program from the database system 50 via the server 40. Whether the SUT 10 includes the motherboard, the graphic card and a memory stick, the download module 210 downloads the first test program, the second test program and the third test program from the database system 50 via the server 40.

Each type of the parts 100 is tested under the test program which is transmitted at a specific baud rate. For example, the motherboard is tested under the first test program and the first test program may be transmitted at the baud rate of 9600 bit per second (bit/s). The graphic card is tested under the second test program, and the second test program may be transmitted at the baud rate of 115200 bit/s.

The determination module 220 determines whether the one or more test programs are transmitted at different baud rates. In one embodiment, whether the one or more parts 100 tested by the SUT 10 includes at least two types, the one or more test programs are transmitted at different baud rates. For example, whether the SUT 10 includes the motherboard and the memory stick, the one or more test programs are transmitted at different baud rates. However, whether the SUT 10 includes one type of the parts 100, the one or more test programs are transmitted at the same baud rates. For example, whether the SUT 10 includes one or more graphic cards, the one or more test programs are transmitted at the same baud rates of 115200 bit/s.

The switch module 230 switches to a specific cable 110 which can transmit the one or more test programs at different baud rates. In one embodiment, the switch module 230 switches to a RS-232 serial Y cable. The RS-232 serial Y cable can transmit the one or more test programs at different baud rates.

The sending module 240 sends the one or more test programs to the SUT 10 via the switched cable 110. For example, the sending module 240 sends the first test program and the second test program to the SUT 10 via the RS-232 serial Y cable.

The execution module 250 starts the CLI and controls the SUT 10 to execute the one or more test programs via the CLI. In one embodiment, whether the one or more test programs include the first test program and the second test program, the execution module 250 may firstly control the SUT 10 to execute the first test program in the CLI, after the first test program has been executed, then secondly control the SUT 10 to execute the second test program in the same CLI.

The receiving module 260 receives a test report from the SUT 10 after the one or more parts 100 have been tested. The test report shows whether the parts 100 are qualified or not. For example, whether the test report shows result information such as “Pass,” the one or more parts 100 are tested as qualified. Whether the test report shows result information such as “Fail,” the one or more parts 100 are tested as unqualified.

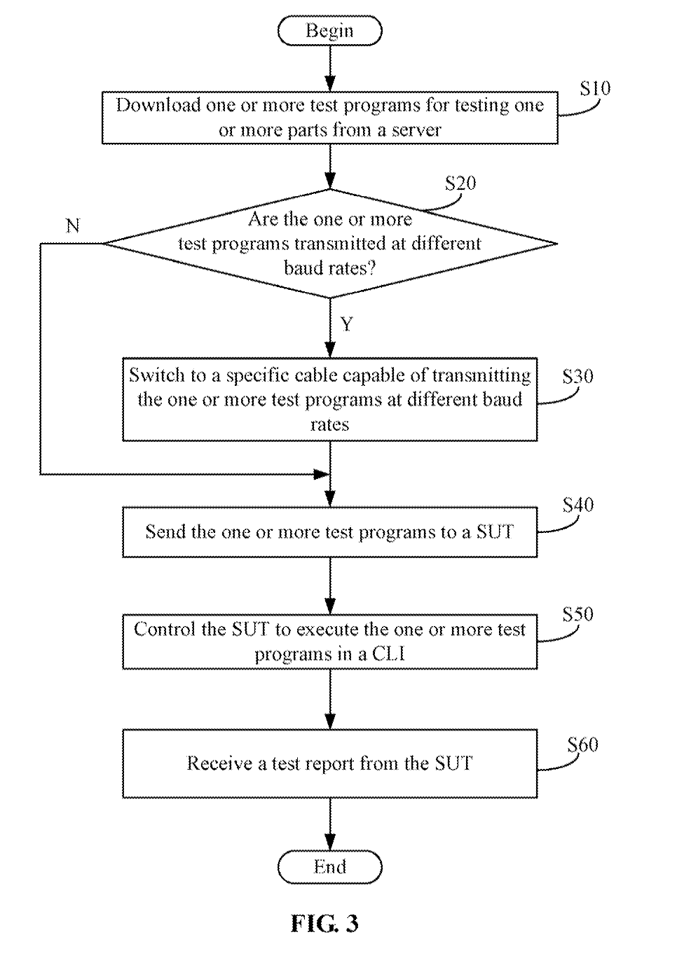

FIG. 3 is a flowchart of one embodiment of a CLI control method using the computing device 20 of FIG. 1. Depending on the embodiment, additional steps may be added, others deleted, and the ordering of the blocks may be changed.

In step S10, the download module 210 downloads one or more test programs for testing the one or more parts 100 from the server 40. For example, whether the SUT 10 includes two parts 100, the download module 210 downloads two test programs from the database system 50 via the server 40.

In step S20, the determination module 220 determines whether the one or more test programs are transmitted at different baud rates. In one embodiment, whether the SUT 10 includes at least two types of the parts 100, the test programs are transmitted at different baud rates, then procedure goes to step S30. Whether the SUT 10 includes one type of the parts 100, the test programs just are transmitted at one baud rate, then procedure goes to step S40.

In step S30, the switch module 230 switches to a specific cable 110 which can transmit the one or more test programs at different baud rates. In one embodiment, the specific cable is the RS-232 serial Y cable.

In step S40, the sending module 240 sends the one or more test programs to the SUT 10 via the cable 110. In one embodiment, whether the one or more test programs just are transmitted at one baud rate, the sending module 240 transmits the one or more test programs to the SUT 10 via the cable 100 which only transmits the one or more test programs at one baud rate. Whether the one or more test programs are transmitted at different baud rates, the sending module 240 transmits the one or more test programs to the SUT 10 via the RS-232 serial Y cable.

In step S50, the execution module 250 starts the CLI and controls the SUT 10 to execute the one or more test programs via the CLI. For example, the execution module 250 may firstly control the SUT 10 to execute the first test program in the CLI, then secondly control the SUT 10 to execute the second test program in the same CLI.

In step S60, the receiving module 260 receives a test report from the SUT 10 after the one or more parts 100 have been tested. The test report is a test result for testing the parts 100 by the SUT 10. The test result may include a start time, a stop time, an identifier to show whether each of the parts 100 are qualified or not. The identifier may be, but is not limited to, “Pass” or “Fail.” Whether the identifier is “Pass” for the motherboard, the motherboard is tested as qualified. Whether the identifier is “Fail” for the motherboard, the motherboard is tested as unqualified.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, the computing device in communication with a server and a system under test (SUT) using one or more cables, the computing device comprising:
a storage system;
at least one processor; and
one or more programs stored in the storage system and being executable by the at least one processor, the one or more programs comprising:
a download module downloads one or more test programs for testing one or more parts from the server, wherein each of the one or more parts is tested by the SUT using a corresponding test program;
a determination module determines whether the one or more test programs are transmitted at different baud rates;
a switch module switches to a specific cable capable of transmitting the one or more test programs at different baud rates;
a sending module sends the one or more test programs to the SUT via the switched cable;
an execution module starts a command-line interface (CLI) and controls the SUT to execute the one or more test programs via the CLI; and
a receiving module receives a test report from the SUT after the one or more parts have been tested.

2. The computing device of claim 1, wherein the specific cable is a RS-232 serial Y cable.

3. The computing device of claim 1, wherein the one or more test programs are transmitted at different baud rates upon the condition that the one or more parts tested by the SUT comprise at least two types.

4. The computing device of claim 1, wherein the test report comprises whether each of the one or more parts is qualified or unqualified.

5. A command-line interface (CLI) control method implemented by a computing device, the computing device in communication with a server and a system under test (SUT) using one or more cables, the method comprising:
downloading one or more test programs for testing one or more parts from the server, wherein each of the one or more parts is tested by the SUT using a corresponding test program;
determining whether the one or more test programs are transmitted at different baud rates;
switching to a specific cable capable of transmitting the one or more test programs at different baud rates;
sending the one or more test programs to the SUT via the switched cable;
starting a command-line interface (CLI) and controlling the SUT to execute the one or more test programs in the CLI; and
receiving a test report from the SUT after the one or more parts have been tested.

6. The method of claim 5, wherein the specific cable is a RS-232 serial Y cable.

7. The method of claim 5, wherein the one or more test programs are transmitted at different baud rates upon the condition that the one or more parts tested by the SUT comprise at least two types.

8. The method of claim 5, wherein the test report comprises whether each of the one or more parts is qualified or unqualified.

9. A non-transitory computing system-readable medium having stored thereon instructions that, when executed by a computing device, the computing device in communication with a server and a system under test (SUT) using one or more cables, the method comprising:
downloading one or more test programs for testing one or more parts from the server, wherein each of the one or more parts is tested by the SUT using a corresponding test program;
determining whether the one or more test programs are transmitted at different baud rates;
switching to a specific cable capable of transmitting the one or more test programs at different baud rates;
sending the one or more test programs to the SUT via the switched cable;
starting a command-line interface (CLI) and controlling the SUT to execute the one or more test programs in the CLI; and
receiving a test report from the SUT after the one or more parts have been tested.

10. The non-transitory medium of claim 9, wherein the specific cable is a RS-232 serial Y cable.

11. The non-transitory medium of claim 9, wherein the one or more test programs are transmitted at different baud rates upon the condition that the one or more parts tested by the SUT comprise at least two types.

12. The non-transitory method of claim 9, wherein the test report comprises whether each of the one or more parts is qualified or unqualified.
